(19) United States
(12) Patent Application Publication
(10) Pub. No.: US 2011/0069423 A1
(43) Pub. Date: Mar. 24, 2011

(54) PROTECTION CIRCUIT FOR OVER-CURRENT AND SHORT PROTECTION

(75) Inventor: YONG-ZHAO HUANG, Shenzhen City (CN)

(73) Assignees: HONG FU JIN PRECISION INDUSTRY (ShenZhen) CO., LTD., Shenzhen City (TW); HON HAI PRECISION INDUSTRY CO., LTD., LTD (TW)

(21) Appl. No.: 12/630,857

(22) Filed: Dec. 4, 2009

(30) Foreign Application Priority Data
Sep. 18, 2009 (CN) 200910307304.1

(51) Int. Cl. H02H 3/00

(52) U.S. Cl. 361/100

(57) ABSTRACT

A protection circuit includes a switch and a transistor. A first end of the switch is connected to a power source. A second end of the switch is connected to an electronic device via a first resistor. A third end of the switch is connected to the power source via a second resistor. A base of the transistor is connected to the second of the transistor via a third resistor, and grounded via a fourth resistor. A collector of the transistor is connected to the power source. An emitter of the transistor is connected to the electronic device.

### BACKGROUND

1. Technical Field

The present disclosure relates to protection circuits and, particularly, to a protection circuit for over-current protecting and short protecting.

2. Description of Related Art

Nowadays, electronic devices usually include short protection circuits and over-current protection circuits. When an electronic device is short-circuited, a short protection circuit of the electronic device will disconnect the power source to protect the electronic device. When the current of the electronic device is over-current, an over-current protection circuit of the electronic device will disconnect the power source to protect the electronic device. However, it is usually costly to design and manufacture the short protection circuit and the over-current protection circuit.

### BRIEF DESCRIPTION OF THE DRAWINGS

FIG. 1 is a circuit diagram of a first exemplary embodiment of a protection circuit connected to an electronic device.

FIG. 2 is a circuit diagram of a second exemplary embodiment of a protection circuit connected to an electronic device.

### DETAILED DESCRIPTION

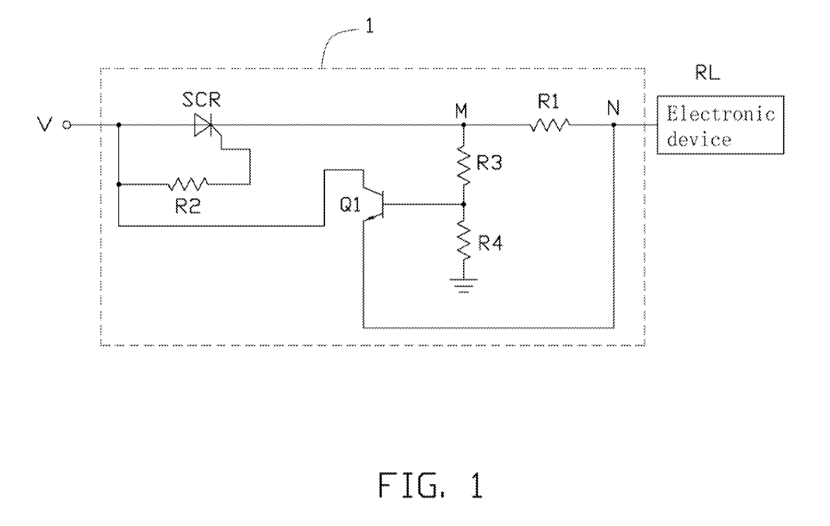

Referring to FIG. 1, a first exemplary embodiment of a protection circuit 1 includes a thyristor SCR, a transistor Q1, and four resistors R1, R2, R3, R4. The protection circuit 1 can disconnect a power source V from an electronic device RL when the electronic device RL is short-circuited or over-current.

An anode of the thyristor SCR functions as an input of the protection circuit 1, and is connected to the power source V. A cathode of the thyristor SCR is connected to the electronic device RL via the resistor R1. A gate of the thyristor SCR is connected to the anode of the thyristor SCR via the resistor R2.

The cathode of the thyristor SCR is also connected to a base of the transistor Q1 via the resistor R3. The base of the transistor Q1 is grounded via the resistor R4. A collector of the transistor Q1 is connected to the anode of the thyristor SCR. An emitter of the transistor Q1 is connected to a node N between the resistor R1 and the electronic device RL. In the embodiment, a node M is connected by the cathode of the thyristor SCR, the resistor R3, and the resistor R1. The node N functions as an output of the protection circuit 1 and is connected by the resistor R1, the emitter of the transistor Q1, and the electronic device RL.

When there is no over-current and no over-voltage in the electronic device RL, the thyristor SCR is turned on. The power source V provides the voltage for the electronic device RL via the thyristor SCR and the resistor R1 in turn. At this time, the electronic device RL operates normally.

When over-current happens in the electronic device RL, a voltage difference between the voltage at the node M divided by the resistors R3, R4 and the voltage at the node N is more than 0.7 volts, that is to say, a voltage difference between the base and the emitter of the transistor Q1 is more than 0.7 volts. The transistor Q1 is turned on. The voltage between the anode and the cathode of the thyristor SCR is less than an operating voltage of the thyristor SCR. As a result, the thyristor SCR turns off. Therefore, the transistor Q1 turns off. The power source V becomes disconnected from the electronic device RL, to protect the electronic device RL. It can be understood that over-current means that the current of the electronic device RL is more than a rated current I_{Max} of the electronic device RL.

The mechanism that the protection circuit 1 protects the electronic device RL when the electronic device RL is short-circuited will be described as follow.

Based on the structure of the protection circuit 1, the voltage at the node M V_{M} can be obtained via a first equation: V_{M}=I_{L}R₁+V_{OUT}. It can be understood that I_{L} denotes the current flowing the electronic device RL. R₁ denotes the resistance of the resistor R1. V_{OUT} denotes the voltage at the output of the protection circuit 1.

The voltage at the base of the transistor Q1 can be obtained via a second equation:

$${V}_{B} = \frac{R 4}{R 3 + R 4} \cdot {V}_{M} = \frac{R 4}{R 3 + R 4} \cdot ( {I}_{L} {R}_{1} + {V}_{OUT} ) .$$

The voltage at the emitter of the transistor Q1 can be obtained via a third equation: V_{E}=V_{OUT}. As a result, the voltage between the base and the emitter of the transistor Q1 can be obtained via a fourth equation:

$${V}_{BE} = {V}_{B} - {V}_{E} = \frac{R 4}{R 3 + R 4} \cdot ( {I}_{L} R 1 + {V}_{OUT} ) - {V}_{OUT} .$$

It can be understood that R3 denotes the resistance of the resistor R3. R4 denotes the resistance of the resistor R4.

Supposing that

$$K = \frac{R 4}{R 3 + R 4} ,$$

the voltage between the base and the emitter of the transistor Q1 can be obtained via a fifth equation:

V_{BE}=K(I_{L}R1+V_{OUT})−V_{OUT}=KI_{L}R1+V_{OUT}(K−1).

As a result, the current flowing through the electronic RL can be obtained as a sixth equation:

$${I}_{L} = \frac{{V}_{B} - {V}_{OUT} ( K - 1 )}{KR 1} .$$

When the electronic device RL is short-circuited, the voltage at the output of the protection circuit 1 equals zero. At this time, the current I_{SL} flowing through the protection circuit 1 can be obtained by applying a seventh equation:

$${I}_{SL} = \frac{{V}_{BE}}{KR 1} .$$

As a result, when the electronic device RL is short-circuited, the maximum current I_{SL}(Max) flowing through the protection circuit 1 can be obtained as an eighth equation:

$${I}_{SL ( Max )} = \frac{{V}_{BE} ( Max )}{KR 1} .$$

It can be understood that V_{BE}(Max) denotes the maximum voltage at the output of the protection circuit 1.

When the electronic device RL is not short-circuited, the current I_{L} flowing through the protection circuit 1 can be obtained as a ninth equation:

$${I}_{L} = \frac{{V}_{BE} - {V}_{OUT} ( K - 1 )}{KR 1} .$$

As a result, when the electronic device RL is not short-circuited, the maximum current I_{L}(Max) flowing through the protection circuit 1 can be obtained as a tenth equation:

$${I}_{L ( Max )} = \frac{{V}_{BE} ( Max ) - {V}_{OUT} ( K - 1 )}{KR 1} .$$

As described above, the maximum current I_{L}(Max) flowing through the protection circuit 1 when the electronic device RL is not short-circuited is more than the maximum current I_{SL}(Max) flowing through the protection circuit 1 when the electronic device RL is short-circuited.

In the protection circuit 1, the maximum current I_{L}(Max) flowing through the protection circuit 1 when the electronic device RL is not short-circuited is set to be equal to the rated current I_{MAX} of the electronic device RL. As a result, the rated current I_{Max} of the electronic device RL can be obtained as an eleventh equation:

$${I}_{Max} = \frac{{V}_{BE} ( Max ) - {V}_{OUT} ( K - 1 )}{KR 1} .$$

As a result, even if the electronic device RL is short-circuited, the current flowing through the protection circuit 1 is less than the rated current I_{Max} of the electronic device RL. Therefore, the protection circuit 1 can protect the electronic device RL when the electronic device RL is short-circuited.

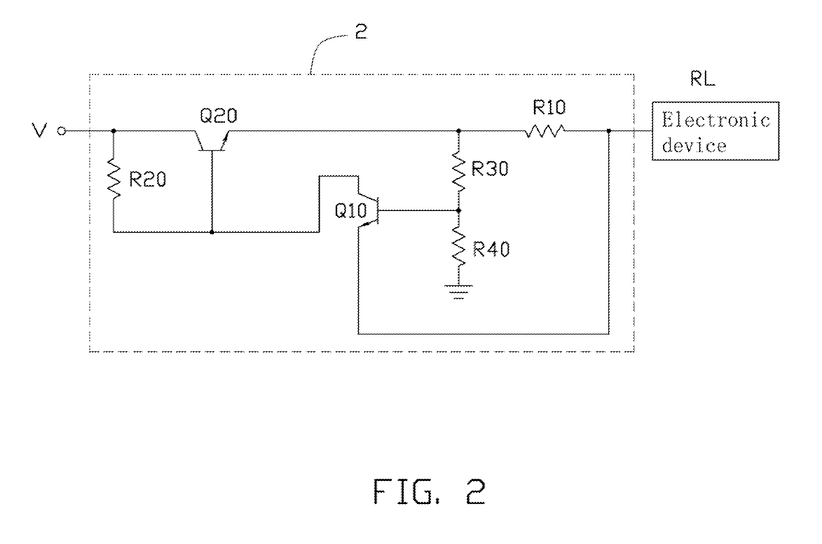

Referring to FIG. 2, a second exemplary embodiment of a protection circuit 2 includes two transistors Q10 and Q20, four resistors R10, R20, R30, and R40.

A collector of the transistor Q20 functions as an input of the protection circuit 2, and is connected the power source V. An emitter of the transistor Q20 is connected to the electronic device RL via the resistor R10. A base of the transistor Q20 is connected to the collector of the transistor Q20 via the resistor R20.

The emitter of the transistor Q20 is also connected to a base of the transistor Q10 via the resistor R30. The base of the transistor Q10 is grounded via the resistor R40. A collector of the transistor Q10 is connected to the base of the transistor Q20. An emitter of the transistor Q10 is connected to a node between the resistor R10 and the electronic device RL.

When there is no over-current and no over-voltage in the electronic device RL, the second transistor Q20 is turned on. The power source V provides the voltage for the electronic device RL via the second transistor Q20 and the resistor R10 in turn. At this time, the electronic device RL operates normally.

When over-current happens in the electronic device RL, a voltage difference between the voltage at a node between the resistors R30, R40 and the voltage at the emitter of the transistor Q10 is more than 0.7 volts, that is to say, a voltage difference between the base and the emitter of the transistor Q10 is more than 0.7 volts. The transistor Q10 is turned on. The voltage between the base and the emitter of the transistor Q20 is less than an operating voltage of the transistor Q20. As a result, the transistor Q20 turns off. Therefore, the transistor Q10 turns off. The power source V becomes disconnected from the electronic device RL, to protect the electronic device RL.

The protection circuit 2 in the second embodiment protects the electronic device RL from short-circuiting using the same mechanism the protection circuit 1 in the first embodiment does in protecting the electronic device RL from short-circuiting.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A protection circuit for an electronic device, the protection circuit comprising:
a switch, wherein a first end of the switch is connected to a power source, a second end of the switch is connected to the electronic device via a first resistor, a third end of the switch is connected to the power source via a second resistor; and
a first transistor, wherein a base of the first transistor is connected to the second end of the switch via a third resistor, and grounded via a fourth resistor, a collector of the first transistor is connected to the power source, an emitter of the first transistor is connected to the electronic device.

2. The protection circuit of claim 1, wherein the switch is a thyristor, an anode of the thyristor functions as the first end of the switch, a cathode of the thyristor functions as the second end of the switch, a gate of the thyristor functions as the third end of the switch.

3. The protection circuit of claim 2, wherein
$${I}_{Max} = \frac{{V}_{BE} ( Max ) - {V}_{OUT} ( K - 1 )}{KR 1} , \\ K = \frac{R 4}{R 3 + R 4} ,$$
I_{Max} denotes a rated current of the electronic device, V_{BE} (Max) denotes the maximum voltage between the base and the emitter of the first transistor, V_{OUT} denotes the voltage of the electronic device, R1 denotes a resistance of the first resistor, R3 denotes a resistance of the third resistor, R4 denotes a resistance of the fourth resistor.

4. The protection circuit of claim 1, wherein the switch is a second transistor, a collector of the second transistor functions as the first end of the switch, an emitter of the second transistor functions as the second end of the switch, a base of the second transistor functions as the third end of the switch.

5. The protection circuit of claim 4, wherein
$${I}_{Max} = \frac{{V}_{BE} ( Max ) - {V}_{OUT} ( K - 1 )}{KR 1} , \\ K = \frac{R 4}{R 3 + R 4} ,$$
I_{Max} denotes a rated current of the electronic device, V_{BE}(Max) denotes the maximum voltage between the base and the emitter of the first transistor, V_{OUT} denotes the voltage of the electronic device, R1 denotes a resistance of the first resistor, R3 denotes a resistance of the third resistor, R4 denotes a resistance of the fourth resistor.
